(19) United States
(12) Patent Application Publication
(10) Pub. No.: US 2026/0321117 A1
(43) Pub. Date: Oct. 15, 2026

(54) EVENT DEVICE WITH DISPLAY DEVICE FOR EVENT DETECTION

(71) Applicant: Honeywell International Inc., Charlotte, NC (US)

(72) Inventors: Benjamin Henry Wolf, Leicester (GB); Daniel Wall, Grevenbroich (DE); Abdallah Yaser Taher Zabalawi, Düsseldorf (DE)

(21) Appl. No.: 19/176,648

(22) Filed: Apr. 11, 2025

(51) Int. Cl. G08B 19/00; G08B 17/10

(52) U.S. Cl. CPC G08B 19/00; G08B 17/10

(57) ABSTRACT

Devices, systems, and methods for an event device with display device for event detection are described herein. In some examples, one or more embodiments include a display device, a detector, a base, a memory, and a processor configured to execute executable instructions stored in the memory to receive an identifier signal including device identifier information for the event device, transmit, based on the identifier signal, a display signal to the display device, and cause, based on the display signal, the display device to display the device identifier information for the event device.

### TECHNICAL FIELD

The present disclosure relates to devices, systems, and methods for an event device with display device for event detection.

### Background

Facilities, such as commercial facilities, office buildings, hospitals, campuses (e.g., including buildings and outdoor spaces), and the like, may have an event detection system that can be triggered during an event, such as an emergency situation (e.g., a fire) to warn occupants to evacuate. Such an event detection system may include an alarm system having a control panel and a number of event devices (e.g., sensors, sounders, pull stations, etc.) located throughout the facility (e.g., on different floors and/or in different rooms of the facility) that can perform an action when an event (e.g., a hazard event, a fault event, etc.) is occurring in the facility. In an example of an event, the number of event devices may provide a notification of the event to the occupants of the facility via alarms and/or other mechanisms.

### BRIEF DESCRIPTION OF THE DRAWINGS

FIG. 1 is an example of an event device with a display device, in accordance with one or more embodiments of the present disclosure.

FIG. 2 is an example of a system with event devices for event device with display device for event detection, in accordance with one or more embodiments of the present disclosure.

FIG. 3 is an example of a method for displaying device identifier information via an event device with display device, in accordance with one or more embodiments of the present disclosure.

FIG. 4 is an example of an event device with display device for event detection, in accordance with one or more embodiments of the present disclosure.

### DETAILED DESCRIPTION

Devices, systems, and methods for an event device with display device for event detection are described herein. In some examples, one or more embodiments include a display device, a detector, a base, a memory, and a processor configured to execute executable instructions stored in the memory to receive an identifier signal including device identifier information for the event device, transmit, based on the identifier signal, a display signal to the display device, and cause, based on the display signal, the display device to display the device identifier information for the event device.

A facility can utilize an event detection system in order to warn occupants of the facility of an emergency event, such as a fire or other events. An event detection system can be a system of devices that operate to collect information about a facility and provide the collected information for analysis. Such an event detection system can also take actions based on the collected information, such as providing an audible and/or visible warning in an emergency event. For example, the event detection system can utilize event devices to warn occupants of an emergency event occurring in a space, such as a fire. As used herein, the term “event device” refers to a device that can receive an input relating to an event and/or generate an output relating to an event. Such event devices can be a part of the event detection system of a space in a facility/in the facility at large and can include devices such as fire sensors, smoke detectors, heat detectors, carbon monoxide (CO) detectors, or combinations of these; air quality sensors; interfaces; manual call points (MCPs); pull stations; input/output modules; aspirating units; fire doors; and/or audio/visual devices (e.g., speakers, sounders, flashers, buzzers, microphones, cameras, video displays, video screens, etc.), relay output modules, among other types of event devices. Such event devices may also include self-test capabilities.

In some instances, event devices can include labels. The label for an event device can display certain information about the event device, including identification information for the event device. For example, an event device label can include a device number, such as an identification number, that uniquely identifies the event device from other event devices in the system. The event device label can further include a zone that the event device is monitoring in the facility.

Device labels are typically physical labels that include device identifier information that is printed on the device label. The physical labels are typically attached to event devices manually throughout the facility. Such attachment may be by way of a sticker or other fastening means.

Generation and installation of the physical labels takes significant manual effort. For example, all event devices in the facility have to have device and zone numbers confirmed during the commissioning process for the event detection system. All of the physical labels are then to be printed out for every event device in the facility, separated, and attached to the correct event devices.

These tasks can take a large amount of time and are subject to human error. For example, a technician may attach the wrong physical label to a particular event device, which can cause the sequence of event devices to be incorrect. Further, if the event device configuration in the facility is changed at a later date (e.g., past commissioning), the labels may have to be re-sequenced for all of the event devices in the facility.

An event device with display device for event detection, according to the disclosure, can allow for the use of a display device to display device identifier information for event devices. The display device can be easily installed or be included as part of the event device itself. The display device can display device identifier information for the event device according to an electrical signal. This approach can allow for the device identifier information for an event device to be displayed without having to print, separate, and attach physical labels. Further, the display device can allow for dynamic updating and display of device identifier information in an example in which the event device configuration in the facility is changed. Such an approach can allow for more efficient and less costly labeling of event devices, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

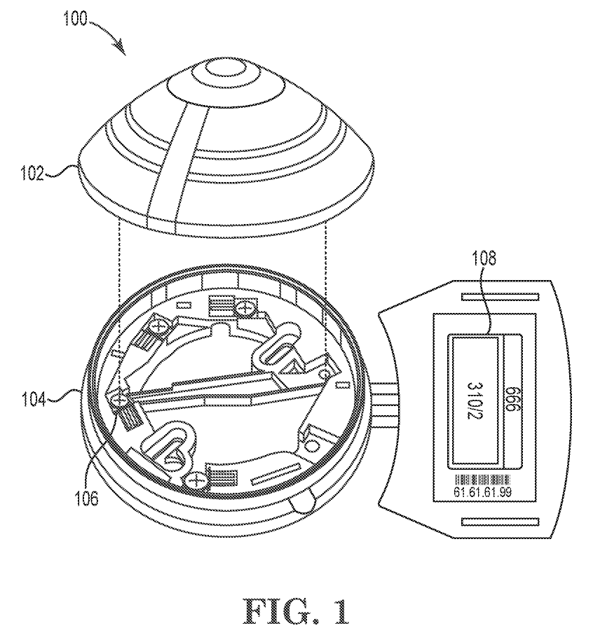

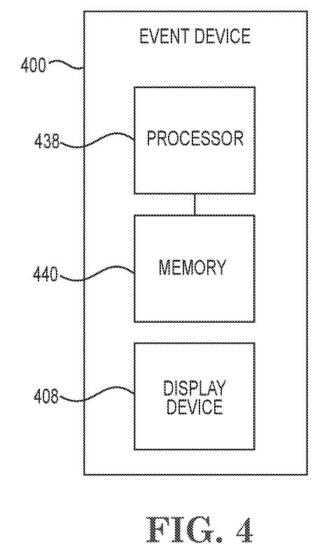

The figures herein follow a numbering convention in which the first digit or digits correspond to the drawing figure number and the remaining digits identify an element or component in the drawing. Similar elements or components between different figures may be identified by the use of similar digits. For example, 102 may reference element “00” in FIG. 1, and a similar element may be referenced as 400 in FIG. 4.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designator “N”, as used herein, particularly with respect to reference numerals in the drawings, indicates that a number of the particular feature so designated can be included with a number of embodiments of the present disclosure.

FIG. 1 is an example of an event device 100 with a display device 108, in accordance with one or more embodiments of the present disclosure. As illustrated in FIG. 1, the event device 100 can include the display device 108, a detector 102, and a base 104.

As illustrated in FIG. 1, the event device 100 can include a detector 102. The detector 102 can be a device that detects events and/or changes in its environment and transmits those detected events and/or changes for processing and/or analysis. For example, the detector 102 can be a portion of the event device that detects events. As previously mentioned above, event devices can be utilized to detect various types of events in a facility, and the detector 102 can be the portion of the event device that detects such types of events, including fire, smoke, heat, CO, air quality, combinations thereof, etc. The detector 102 can include a processor and memory to receive an identifier signal, transmit, based on the identifier signal, a display signal to a display device 108, and cause, based on the display signal, the display device 108 to display the device identifier information for the event device 100, as is further described herein.

The detector 102 can be connected to a base 104. The base 104 can be a rigid support structure that the detector 102 attaches to. For example, the base 104 can be attached to a surface, such as a wall, ceiling, or other type of surface, and the detector 102 can be attached to the base 104 to affix the detector 102 in place in order to monitor for events in a facility.

As illustrated in FIG. 1, the event device 100 can further include a display device 108. As used herein, the term “display device” refers to an output device that includes a display panel that displays information provided by an electrical signal in a visual and/or tactile form. As used herein, the term “display panel” refers to an area of a display device that displays information. For example, the event device 100 can include the display device 108 having a display panel that can display information such as text, videos, images, or combinations thereof as a result of an electrical signal provided to the display from the detector 102, a mobile device (e.g., not illustrated in FIG. 1), and/or any other device.

In some examples, the display device 108 can be an electronic ink (e-ink) display. However, embodiments of the present disclosure are not so limited. For example, the display device 108 can be a light emitting diode (LED) display, an organic LED (OLED) display, quantum dot LED (QLED) display, liquid crystal display (LCD), plasma display, MicroLED display, and/or any other type of display or combination thereof.

In some examples, the display device 108 can be connected to the base 104. For example, the display device 108 can be a separate piece from the base 104 and can be connected to the base 104 by various means, such as by fastener, by a snap-fit, by an interference fit, adhesive, etc.

In some examples, the display device 108 can be formed into the base 104. For example, the display device 108 can be manufactured as a portion of the base 104 itself.

The base 104 can include an electrical contact 106. As used herein, the electrical contact 106 can be a conductive material that allows for the completion of an electrical circuit. For example, the event device 100 can provide power to the display device 108 via the electrical contact 106. Additionally, the event device 100 can communicate data with a control panel in the facility through a system of connected event devices via the electrical contact 106. The system of connected event devices can include, for example, an event device loop, radial circuits, spurs, wireless event devices, etc. Accordingly, the event device 100 can provide power to the display device 108, communicate with a control panel regarding the detection of events in the facility, and/or cause the display device 108 to display device identifier information for the event device 100, as is further described herein.

In some examples, the electrical contact 106 can be included as part of a printed circuit board (PCB). The PCB can allow for additional functions to be performed by the event device 100, including relaying a signal to a remotely located LED(s) (e.g., not illustrated in FIG. 1) to cause the remotely located LED(s) to emit light, indicating a detected event, fault, etc.

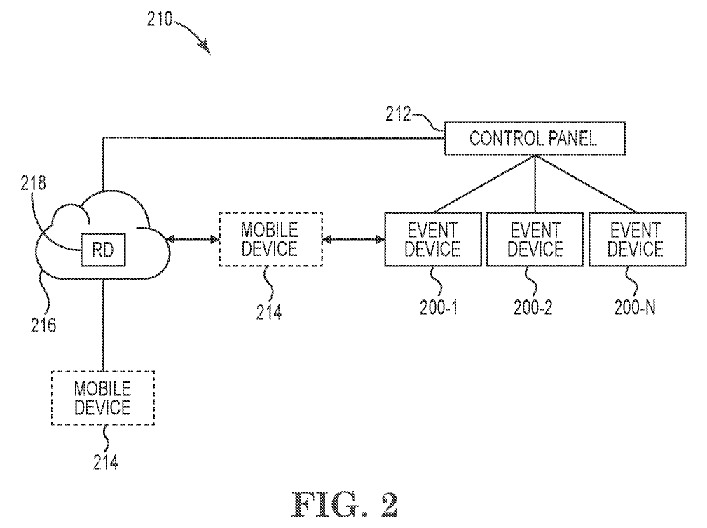

As mentioned above, the event device 100 can cause the display device 108 to display device identifier information. For example, the event device 100 can receive an identifier signal including device identifier information for the event device 100, transmit, based on the identifier signal, a display signal to the display device 108 via the electrical contact 106, and cause, based on the display signal, the display device 108 to display the device identifier information for the event device 100, as is further described in connection with FIG. 2. Additionally, various methods to receive the identifier signal and various methods to transmit the display signal are further described in connection with FIG. 2.

FIG. 2 is an example of a system 210 with event devices 200 with display devices for event detection, in accordance with one or more embodiments of the present disclosure. The system 210 can include event devices 200-1, 200-2, 200-N (referred to collectively herein as event devices 200), a control panel 212, a mobile device 214, and a remote computing device 216. The remote computing device 216 can include a remote database 218.

Although not illustrated in FIG. 2, each of the event devices 200 can include a display device. Each of the event devices 200 can cause their respective display devices to display device identifier information for their respective event devices 200, as well as other information, as is further described herein.

As mentioned above, the facility can include an event detection system including the event devices 200. The event detection system can further include a control panel 212 connected to the event devices 200.

The control panel 212 can be connected to the event devices 200, transmit a plurality of commands to the event devices 200, and/or provide power to the event devices 200. The control panel 212 can apply a voltage to a system of connected event devices in order to power event devices 200 included in the system of connected event devices. Such power can allow the event devices 200 to perform actions, such as communication between event devices 200 and the control panel 212, self-test procedures, and/or provide an audible and/or visible warning in an event, among other actions.

The control panel 212 can be connected to the event devices 200 and/or to a remote computing device 216 via a wired and/or wireless network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), Near Field Communication (NFC), infrared (IR) communication, Public Switched Telephone Network (PSTN), radio waves, and/or the Internet, among other types of network relationships.

As illustrated in FIG. 2, the system 210 can include a remote computing device 216, which can be remotely located from the event devices 200, the control panel 212, and/or the mobile device 214. The remote computing device 216 can be a computing device operating as and/or included in part of a cloud-computing environment. For instance, the remote computing device 216 can be a computing device operating as part of a cloud computing environment remotely located from the control panel 212 and the mobile device 214 and can receive data from the control panel 212 and/or the mobile device 214 via a network relationship.

As mentioned above, each of the event devices 200 can include a display device (e.g., not illustrated in FIG. 2). The display devices can each display device identifier information for their respective event device, as is further described herein.

Examples described herein utilize event device 200-1. However, embodiments of the disclosure are not so limited. For example, the methods described herein can be utilized by any of the event devices 200 included in the system 210.

Event device 200-1 can receive an identifier signal. A signal can be, for instance, an electromagnetic or electrical current that carries data from one system or network to another. The identifier signal, received by the event device 200-1, can include device identifier information for the event device 200-1.

Device identifier information can include information that characterizes or describes the particular event device. For example, the device identifier information included in the identifier signal can include a unique device identifier associated with the event device 200-1 (e.g., a unique series of numbers and/or characters that uniquely identify each event device), a zone identifier of the facility in which the event device 200-1 is located and/or monitors (e.g., a unique series of numbers and/or characters that uniquely identify each zone in the facility), a location of the event device 200-1 in the system of connected event devices that includes the plurality of event devices in the system 210 (e.g., the event devices 200-1, 200-2, 200-N, etc.), a type of event device, etc. For instance, the device identifier information included in the identifier signal received by the event device 200-1 can include the unique device identifier for event device 200-1 (e.g., Device 666), the location in the system of connected event devices, the zone identifier of the facility in which the event device 200-1 is located (e.g., zone 310/2), the location of the event device 200-1 in the system of connected event devices (e.g., Device 1), a type of event device (e.g., a heat detector), etc. Event devices 200-2 and 200-N can also receive identifier signals including device identifier information unique to those event devices 200-2, 200-N.

In some examples, the event device 200-1 can receive the identifier signal from the control panel 212. For example, the event device 200-1 can periodically receive the identifier signal from the control panel 212, such as once every 24 hours, once every week, or once every month, etc. The period at which the identifier signal is transmitted from the control panel 212 to the event devices (e.g., event device 200-1) can be modifiable. Periodic transmission for the identifier signal to the event device 200-1 can allow for the event device 200-1 to update its displayed device identifier information in an instance in which the device identifier information for the event device 200-1 is updated at the control panel (e.g., if a new event device is added to the system of connected event devices, if event devices are removed from the system of connected event devices, a new naming scheme is utilized, etc.)

However, in some examples, the event device 200-1 can receive the identifier signal after receiving a lookup command from a mobile device 214. For example, the mobile device 214 can be connected to the event device 200-1 and transmit a lookup command signal to the event device 200-1. In response to receiving the lookup command signal, the event device 200-1 can transmit a query to the control panel 212. The control panel 212 can receive the query and, in response, transmit the identifier signal to the event device 200-1. Accordingly, the event device 200-1 can receive the identifier signal from the control panel 212 in response to transmitting the query. Transmission for the identifier signal to the event device 200-1 in response to a lookup command can allow for the event device 200-1 to update its displayed device identifier information in an instance in which the device identifier information for the event device 200-1 is updated at the control panel and a user desires the device identifier information for the event device 200-1 be updated without waiting for the periodic transmission of the identifier signal from the control panel 212 (e.g., if a new event device is added in the loop, if event devices are removed from the loop, a new naming scheme is utilized, etc.)

The event device 200-1 can transmit, based on the identifier signal, a display signal to the display device of the event device 200-1. The display signal can include, for instance, the device identifier information to be displayed, and can cause the display to display the device identifier information, as is further described herein.

In some examples, the event device 200-1 can transmit the display signal directly to the display device. For example, the event device 200-1 can transmit the display signal directly to the display device through the electrical contact included in the base (e.g., not illustrated in FIG. 2) of the event device 200-1. The event device 200-1 can transmit the display signal directly to the display device via signal pulsing.

In some examples, the event device 200-1 can transmit the display signal indirectly to the display device. For example, the event device 200-1 can transmit the display signal to the mobile device 214 to cause the mobile device 214 to transmit the display signal to the display device. The event device 200-1 can wirelessly transmit the display signal to the mobile device 214 via various transmission techniques (e.g., Bluetooth, Infrared, etc.), and the mobile device 214 can further transmit the display signal to the display device via various transmission techniques (e.g., Bluetooth, Infrared, etc.).

In some examples, the event device 200-1 can utilize a verification technique to ensure a technician utilizing the mobile device 214 is connected to the correct event device 200-1. For instance, in an area in the facility that may include multiple event devices 200 (e.g., 200-1, 200-2), it can be beneficial to provide a verification mechanism to ensure the correct event device 200-1 is being communicated with.

The mobile device 214 can connect to the event device 200-1. In response to the mobile device 214 connecting to the event device 200-1, the event device 200-1 can transmit an indicator signal to the display device. The indicator signal can cause the display device of the event device 200-1 to indicate the mobile device 214 is connected to the event device. For example, the indicator signal can cause the display device of the event device 200-1 to be color-coded blue (e.g., or any other particular color), indicating to a user of the mobile device 214 that the mobile device 214 is connected to the event device 200-1.

Although the indicator signal is described above as causing the display device of the event device 200-1 to be color-coded blue, embodiments are not so limited. For example, the indicator signal can cause the display device of the event device 200-1 to blink the color blue on and off, turn the display on and off, cause the display/flash to be any other particular color, among other indicating/notification mechanisms.

Accordingly, based on the display signal, the event device 200-1 can cause the display device of the event device 200-1 to display the device identifier information for the event device 200-1. For example, the display device for the event device 200-1 can display the unique device number for event device 200-1 (e.g., Device 666), the zone number of the facility in which the event device 200-1 is located (e.g., zone number 310/2), etc.

In some examples, the event device 200-1 can include a unique code on the event device 200-1. For example, the unique code can be a bar code, a universal product code (UPC), a data matrix code, a quick response (QR) code, etc. The mobile device 214 can utilize an image capture device, such as a camera, to read the unique code on the event device 200-1. Upon reading the unique code, the mobile device 214 can determine, via the remote database 218, the device identifier information for the event device 200-1.

For instance, the mobile device 214 can transmit the unique code information to the remote database 218 (e.g., included in the remote computing device 216). The remote computing device 216 can perform a lookup in the remote database 218 for the device identifier information for the event device 200-1 and transmit the device identifier information to the mobile device 214. Accordingly, the mobile device 214 can transmit a signal to the display device of the event device 200-1. The signal can include the device identifier information (e.g., from the remote database 218) and can cause the display device of the event device 200-1 to display the device identifier information for the event device 200-1.

In some examples, the event device 200-1 may detect an event in the facility. In response to a detector of the event device 200-1 detecting an event (e.g., the heat detector detecting heat exceeding a threshold value, indicating a possible fire), the event device 200-1 can transmit an event signal to the display device of the event device 200-1. The event signal can cause the display device of the event device 200-1 to indicate, based on the event signal, that the event was detected. The display device can indicate that the event was detected by, for example, color-coding the display device red, flashing red on the display device, etc., while also displaying the device identifier information for the event device 200-1.

In some examples, the event device 200-1 may detect a fault in the detector of the event device 200-1. In response to a detector of the event device 200-1 having a fault, the event device 200-1 can transmit a fault signal to the display device of the event device 200-1. The fault signal can cause the display device of the event device 200-1 to indicate, based on the fault signal, that the event device 200-1 has a fault. The display device can indicate the fault by, for example, color-coding the display device yellow, flashing yellow on the display device, etc., while also displaying the device identifier information for the event device 200-1.

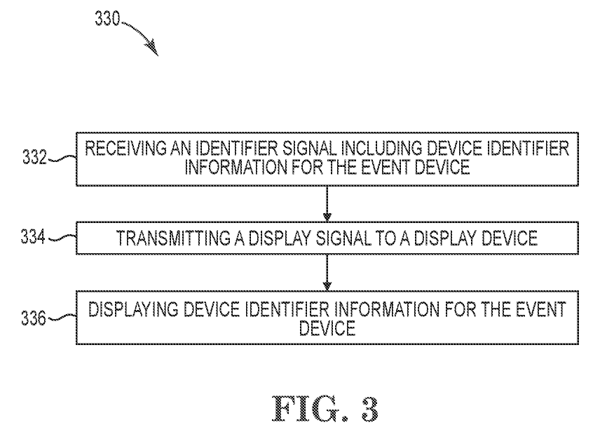

FIG. 3 is an example of a method 330 for transmitting event messages to event response stations, in accordance with one or more embodiments of the present disclosure. The method 330 can be performed by, for example, an event device, a control panel, a mobile device, and/or a remote computing device (e.g., event devices 200, control panel 212, mobile device 214, remote computing device 216, previously described in connection with FIG. 2).

At 332, the method 330 includes receiving, by an event device including a display device, an identifier signal including device identifier information for the event device. In some examples, the event device can periodically receive the identifier signal from the control panel. In some examples, the event device can receive the identifier signal from the control panel after receiving a lookup command from the mobile device.

At 334, the method 330 includes transmitting, by the event device based on the identifier signal, a display signal to the display device. In some examples, the event device can transmit the display signal directly to the display device through an electrical contact included in a base of the event device. In some examples, the event device can transmit the display signal indirectly to the display device via the mobile device.

At 336, the method 330 includes displaying, by the display device based on the display signal, device identifier information for the event device. For example, the device identifier information included in the identifier signal can include a unique device number associated with the event device, a zone number of the facility in which the event device is located and/or monitors, a type of event device, etc.

Accordingly, an event device with display device for event detection, according to the disclosure, can allow for the use of a display device to display device identifier information for event devices. Such an approach can allow for the display device to easily update the device identifier information for event devices if such device identifier information changes. Additionally, the display device can serve to notify users of various types of information (e.g., connectivity status, emergency event status, fault status, etc. Such an approach can allow for more efficient and less costly labeling of event devices, as compared with previous approaches.

FIG. 4 is an example of an event device 400 with display device 408 for event detection, in accordance with one or more embodiments of the present disclosure. As illustrated in FIG. 4, the event device 400 can include a memory 440 and a processor 438 for an event device 400 with display device 408 for event detection, in accordance with the present disclosure.

The memory 440 can be any type of storage medium that can be accessed by the processor 438 to perform various examples of the present disclosure. For example, the memory 440 can be a non-transitory computer readable medium having computer readable instructions (e.g., executable instructions/computer program instructions) stored thereon that are executable by the processor 438 for an event device 400 with display device 408 for event detection in accordance with the present disclosure.

The memory 440 can be volatile or nonvolatile memory. The memory 440 can also be removable (e.g., portable) memory, or non-removable (e.g., internal) memory. For example, the memory 440 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 440 is illustrated as being located within event device 400, embodiments of the present disclosure are not so limited. For example, memory 440 can also be located internal to another computing resource (e.g., enabling computer readable instructions to be downloaded over the Internet or another wired or wireless connection).

The processor 438 may be a central processing unit (CPU), a semiconductor-based microprocessor, and/or other hardware devices suitable for retrieval and execution of machine-readable instructions stored in the memory 664.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. An event device for event detection in a facility, comprising:
a display device;
a detector;
a base;
a memory; and
a processor configured to execute executable instructions stored in the memory to:
receive an identifier signal including device identifier information for the event device;
transmit, based on the identifier signal, a display signal to the display device; and
cause, based on the display signal, the display device to display the device identifier information for the event device.

2. The event device of claim 1, wherein the base includes an electrical contact.

3. The event device of claim 2, wherein the processor is configured to cause the display device to display the device identifier information by transmitting the display signal to the display device via the electrical contact.

4. The event device of claim 2, wherein the event device:
provides power to the display device via the electrical contact; and
communicates, via the electrical contact, data with a control panel in the facility on an event device loop.

5. The event device of claim 2, wherein the electrical contact is included in a printed circuit board (PCB).

6. The event device of claim 1, wherein the display device is connected to the base.

7. The event device of claim 1, wherein the display device is formed into the base.

8. The event device of claim 1, wherein the device identifier information includes at least one of:
a unique device identifier associated with the event device;
a location of the event device in a system of connected event devices;
a zone identifier of the facility in which the event device is located.

9. The event device of claim 1, wherein the detector of the event device transmits the display signal directly to the display device via signal pulsing.

10. The event device of claim 1, wherein the detector of the event device transmits the display signal to a mobile device to cause the mobile device to transmit the display signal to the display device.

11. A method, comprising:
receiving, by a detector of an event device including a display device, an identifier signal including device identifier information for the event device;
transmitting, by the event device based on the identifier signal, a display signal from the detector to the display device; and
displaying, by the display device based on the display signal, device identifier information for the event device.

12. The method of claim 11, wherein the method includes receiving, by the event device, the identifier signal periodically from a control panel in a facility.

13. The method of claim 11, wherein the method includes receiving, by the event device, a lookup command from a mobile device connected to the event device.

14. The method of claim 13, wherein the method includes:
transmitting, by the event device in response to receiving the lookup command, a query to a control panel in a facility; and
receiving, by the event device, the identifier signal from the control panel in response to transmitting the query.

15. A system, comprising:
a mobile device; and
an event detection system in a facility, including:
a control panel; and
a number of event devices connected to the control panel, wherein each one of the number of event devices includes a display device;
wherein an event device of the number of event devices is configured to:
receive an identifier signal including device identifier information for the event device;
transmit, based on the identifier signal, a display signal to the display device; and
cause, based on the display signal, the display device to display the device identifier information for the event device.

16. The system of claim 15, wherein:
the event device is configured to transmit, in response to a detector of the event device detecting an event in the facility, an event signal to the display device; and
the display device is configured to indicate, based on the event signal, an event was detected.

17. The system of claim 15, wherein:
the event device is configured to transmit, in response to a detector of the event device having a fault, a fault signal to the display device; and
the display device is configured to indicate, based on the fault signal, the fault was detected.

18. The system of claim 15, wherein the mobile device is configured to:
read a unique code on the event device; and
determine, via a remote database, the device identifier information for the event device.

19. The system of claim 18, wherein the mobile device is configured to transmit a signal to the display device to cause the display device to display the device identifier information for the event device.

20. The system of claim 15, wherein the event device is configured to cause, in response to the mobile device connecting to the event device, the display device to indicate the mobile device is connected to the event device.
